(19) United States
(12) Patent Application Publication
(10) Pub. No.: US 2022/0209575 A1
(43) Pub. Date: Jun. 30, 2022

(54) COMPUTER-IMPLEMENTED METHOD FOR WIRELESS COMMUNICATING AT LOCAL LEVEL WITH THE CONTROL NODES OF AN ELECTRIC SYSTEM

(71) Applicant: ABB Schweiz AG, Baden (CH)

(72) Inventor: Claudio Tacchini, Terranuova Bracciolini (IT)

(21) Appl. No.: 17/612,164

(22) PCT Filed: May 7, 2020
(86) PCT No.: PCT/EP2020/062668

§ 371 Date: Nov. 17, 2021

(30) Foreign Application Priority Data
May 29, 2019 (EP) 19177297.9

(51) Int. Cl. H02J 13/00

(52) U.S. Cl. CPC H02J 13/00022; H02J 13/00032; H02J 13/00004; H02J 13/00002

(57) ABSTRACT

A method for wireless communicating at local level with one or more control nodes of an electric system. Each control node is included in or operatively associated with a corresponding electric or electronic apparatus of the electric system. The method combines path-finder procedures of different types to discover control nodes of interest and allow carrying out a local wireless communication with these latter.

### CROSS-REFERENCE TO RELATED APPLICATIONS

The present application is a National Stage Entry of International Application No. PCT/EP2020/062668, filed on May 7, 2020, which claims the benefit of priority to European Patent Application No. 19177297.9, filed on May 29, 2019, the entire contents of which are incorporated by reference in their entirety herein.

### FIELD OF THE DISCLOSURE

The present disclosure relates to a method for wireless communicating at local level with the control nodes of an electric system.

In a further aspect, the present disclosure relates to a portable computerized device implementing the method.

### BACKGROUND

As is known, electric systems like renewable power generation plants or electric power distribution grids generally include a network of control nodes formed by control devices carrying out protection, diagnostic, monitoring and/or control functionalities.

For example, in a photovoltaic plant, such control nodes are generally formed by control units included in or operatively associated with photovoltaic inverters.

In most recent electric systems, control nodes are normally provided with a wireless communication port and they can generally interact with external portable computerized devices via local wireless communication (e.g. via a WiFi™ communication).

Thus, as control nodes are also often interconnected in a wired manner, each control node can operate as a wireless access point to a variously extended LAN or local subnet.

Even if they are capable of fully satisfying the purposes for which they have been designed, currently available control networks for electric systems show some drawbacks.

Nowadays, in order to communicate with control nodes, e.g. for configuration purposes during the commissioning activities of the electric system, an operator has often to interact with one control node at a time by bringing a portable computerized device in the nearby of each control node.

As it is easy to understand, such an approach is remarkably time-consuming and expensive in terms of manpower since electric systems may include a large number (e.g. tens or hundreds) of control nodes.

In addition, the physical topology of the control nodes normally changes from an electric system to another as it basically depends on installation requirements. An operator does not often have a full knowledge of the topology of the control nodes since this information may be unavailable or not updated for any reason.

Therefore, it may be quite difficult to reach some control nodes due to a lack of information on their actual location or due their uncomfortable position.

In order to mitigate the above issues, an operator may interact in parallel with a plurality of control nodes falling within the wireless communication range of a portable computerized device.

However, this approach may cause relevant problems in selecting the control nodes with which an interaction is actually desired, as control nodes may be close one with another.

Thus, also in this case, the actual topology of the control nodes may constitute a relevant time-consuming factor in the interaction process with the control nodes.

In the state of the art, it is quite felt the need for solutions allowing a computerized device portable by an operator to interact with the control nodes of an electric system through a local wireless communication in quicker and less labor-intensive ways, in particular without warring on the physical topology of the control nodes.

### BRIEF DESCRIPTION OF THE CLAIMS

In order to respond to this need, the present disclosure provides a method for wireless communicating at local level with one or more control nodes of an electric system, according to the claims.

In a general definition, the method, according to the disclosure, includes the following steps:

generating a first list of control nodes including one or more control nodes of interest intended for communication and generating a command to exchange information packets with the control nodes of interest;

checking whether a wireless communication at local level can be established with a control node of interest included in the first list of control nodes;

if a wireless communication at local level can be established with a control node of interest included in the first list of control nodes, selecting the control node of interest as a reference control node;

executing a first path-finder procedure through the reference control node to discover possible control nodes interconnected, in a wired manner, with the reference control node and generating a second list of control nodes including the reference control node and possible control nodes interconnected, in a wired manner, with the reference control node;

selecting possible undiscovered control nodes of interest included in the second list of control nodes and exchanging the information packets with the selected undiscovered control nodes of interest;

checking whether there are still undiscovered control nodes of interest in the first list of control nodes;

if there are no undiscovered control nodes of interest in the first list of control nodes, terminate the method;

if a local wireless communication cannot be established with any control node of interest of the first list of control nodes at the step b) of the method or if there are undiscovered control nodes of interest in the first list of control nodes, executing a second path-finder procedure to generate a third list of control nodes located within a local wireless communication range;

carrying out a determination procedure to check whether a control node of the third list of control nodes is selectable as a reference control node;

if a control node of the third list of control nodes is selectable as a reference control node, repeating the previous steps by starting from step d) and by selecting the selectable control node as a reference control node; or

if no control node of the third list of control nodes is selectable as a reference control node, terminate the method.

The determination procedure includes the following steps:

i.1) checking whether there are undiscovered control nodes of interest included in the third list of control nodes;

i.2) if there are undiscovered control nodes of interest included in the third list of control nodes, checking whether a wireless communication channel can be established with an undiscovered control node of interest included in the third list;

i.3) if a wireless communication channel can be established with an undiscovered control node of interest included in the third list of control nodes, determining that the undiscovered control node of interest is selectable as a reference control node;

i.4) if there are no undiscovered control nodes of interest included in the third list of control nodes or if a wireless communication channel cannot be established with any undiscovered control node of interest included in the third list of control nodes, checking whether a wireless communication channel can be established with any control node included in the third list of control nodes;

i.5) if a wireless communication channel can be established with a control node included in the third list of control nodes, determining that the control node is selectable as a reference control node);

i.6) if a wireless communication channel cannot be established with any control node included in the third list of control nodes, determining that no control node included in the third list of control nodes is selectable as a reference control node.

The first path-finder procedure includes executing a wired network discovery algorithm (e.g. of the DNS-SD type) through the reference control node.

The step e) of the method, according to the disclosure, includes exchanging the information packets with possible undiscovered control nodes of interest in a parallel manner.

The step e) of the method, according to the disclosure, includes exchanging the information packets with possible undiscovered control nodes of interest in a sequential manner.

The second path-finder procedure includes executing a wireless network scanning algorithm (e.g. of the WiFi™ type).

The termination of the method includes providing output data indicative of execution results of the method.

The method, according to the disclosure, includes a step of updating a map of the control nodes of the electric system.

The electric system is a photovoltaic plant, each control node being included in or operatively associated with a photovoltaic inverter of the photovoltaic plant.

In a further aspect, the present disclosure relates to a computer program.

In a further aspect, the present disclosure relates to a portable computerized device.

### BRIEF DESCRIPTION OF THE DRAWINGS

Characteristics and advantages of the disclosure will emerge from the description of example embodiments of the method, according to the disclosure, non-limiting examples of which are provided in the attached drawings, wherein:

FIG. 1 is schematic example showing an electric system, e.g. a photovoltaic plant;

FIG. 2 is a schematic view of a control node of an electric system;

FIG. 3 is a schematic view of a portable computerized device implementing the method, according to the disclosure;

FIGS. 4-5 schematically show the steps of the method, according to the disclosure;

FIGS. 6-9 schematically show an implementation example of the method, according to the disclosure.

### DETAILED DESCRIPTION OF THE DRAWINGS

With reference to the cited figures, the present disclosure relates to a method 100 for wireless communicating at local level with one or more control nodes of an electric system.

For the purposes of the present disclosure, the term “wireless communicating at local level” is mainly referred to wireless communication processes carried out by employing known wireless local networking protocols, such as WiFi™, Bluetooth™, Zigbee™, and the like.

In addition, the term “wireless communication” should be intended in general terms, i.e. referring to unidirectional or bidirectional wireless transmission of information packets PCK. Information packets PCK may include single commands, ordered or non-ordered sequences of commands, data such as configuration data or monitoring data, single messages, ordered or non-ordered sequences of messages, and the like.

Information packets PCK are predefined and stored in suitable memory locations of one or more control nodes of the electric system and/or of a computerized device 50 interacting with the control nodes and implementing the method 100.

The method 100, according to the present disclosure, is particularly adapted for implementation in photovoltaic plants and it will be here described with particular reference to this application field for the sake of brevity only, without intending to limit in any way the scope of the disclosure.

The method 100 of the disclosure may, in fact, be conveniently employed in electric systems of different type, e.g. in wind farms or other distributed power generation plants or in electric power distribution grids.

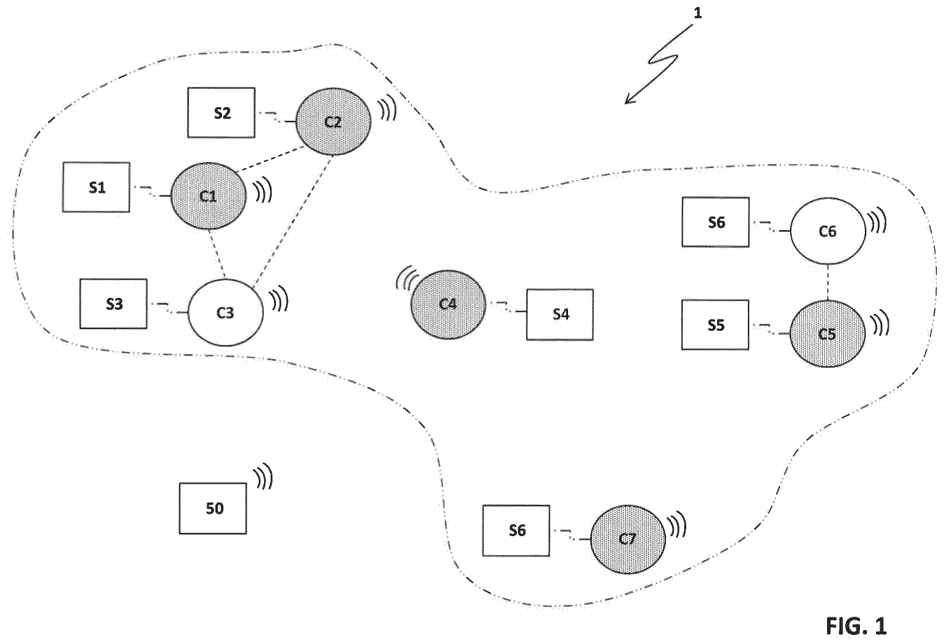

FIG. 1 schematically shows an electric system 1, for example a photovoltaic plant.

The electric system 1 includes a plurality of primary apparatuses S1, S2, S3, S4, S5, S6, S7, for example photovoltaic inverters operatively coupled with corresponding photovoltaic panels or strings (not shown).

Each primary apparatus conveniently includes or is operatively associated with a corresponding control unit C1, C2, C3, C4, C5, C6, C7 adapted to control its functionalities.

Control units C1-C7 form a network of control nodes of the electric system.

Depending on the installation requirements, control nodes C1-C7 are arranged according to a certain physical topology.

Referring to the example of FIG. 1, some control nodes, such as the control node C4, may be isolated from other control nodes and, at the same time, arranged near other control nodes.

Some control nodes, such as the control nodes C1-C3, may be interconnected one with another in a wired manner (thereby forming a LAN or a subnet) and arranged near other control nodes.

Some control nodes, such as the control nodes C5-C6, may be interconnected one with another in a wired manner and arranged far from other control nodes.

Some control nodes, such as the control node C7, may be isolated from other control nodes and arranged far from other control nodes.

The skilled person will certainly understand that other topology configurations different from those of FIG. 1 are possible, according to the needs. However, the exemplary operative arrangements shown in FIG. 1 are normally present in extended networks of control nodes.

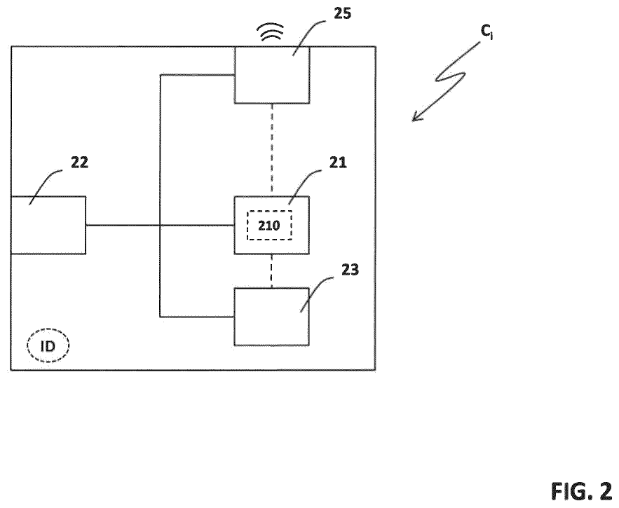

FIG. 2 schematically shows a generic control node Cᵢ (i=1, . . . , 7) of the electric system 1 shown in FIG. 1.

The control node Cᵢ, which may be, for example, the control unit of a photovoltaic inverter of a photovoltaic plant, includes a control module 21, a memory 23 and a power supply module 22 (which may be of known type).

Advantageously, the control module 21 is equipped with suitable data processing resources 210 (e.g. a microprocessor, a digital processing device or the like) capable of executing suitable software instructions stored in the memory 23 to carry out the functionalities foreseen for the corresponding control node Cᵢ.

An important aspect of each generic control node Cᵢ consists in that it is equipped with a wireless communication module 25 (which may be of known type) operatively associated to and interacting with the control module 21.

In operation, the wireless communication module 25 is capable of employing known wireless local networking protocols for communication. In this way, the control node Cᵢ is capable of wireless communicating at local level with an external computerized device. Each generic control node Cᵢ is thus capable of operating as a wireless access point for an external computerized device.

The access to a generic control node Cᵢ by an external computerized device may occur in a manner known to the skilled person. For example, an external computerized device can access to a generic control node Cᵢ by providing a suitable password to this latter.

Conveniently, a generic control node Cᵢ stores, in a memory location, information packets PCK to be exchanged with an external computerized device, if information is transmitted from the control node to the computerized device.

A further important aspect of each generic control node Cᵢ consists in that it is univocally identified by a suitable identification code ID that is known and stored since when the control node itself is installed.

The method 100, according to the disclosure, is particularly suitable for being computer-implemented by means of a portable computerized device 50.

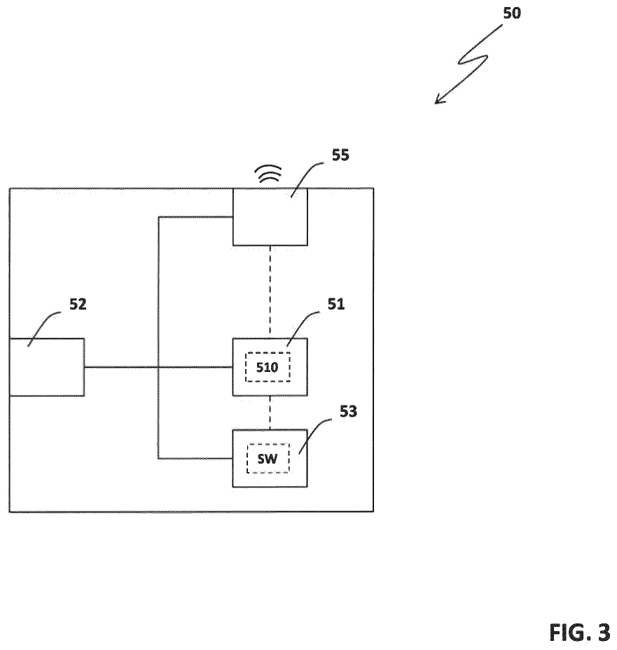

FIG. 3 schematically shows a generic portable computerized device 50, for example a tablet, a portable computer, a smartphone, and the like, suitable for implementing the method 100.

The computerized device includes a control module 51, a memory 53 and a power supply module 52, which may be of known type.

Advantageously, the control module 51 is equipped with suitable data processing resources 510 (e.g. a microprocessor, a digital processing device or the like) capable of executing suitable software instructions to carry out the functionalities foreseen for the computerized device 50.

In particular, the control module 51 is equipped with data processing resources capable of carrying out software instructions SW stored in a memory location to carry out the method 100, according to the disclosure.

The computerized device 50 is equipped with a wireless communication module 55 (which may be of known type) operatively associated to and interacting with the control module 21.

In operation, the wireless communication module 55 is capable of employing known wireless local networking protocols for communication. In this way, the computerized device 50 is capable of wireless communicating at local level with a generic control node Cᵢ of the electric system.

Conveniently, the portable computerized device 50 stores, in a memory location, information packets PCK to be exchanged with one or more control nodes of the electric system, if information is transmitted from the portable computerized device to the control nodes.

In order to ensure a suitable implementation of the method 100, the computerized device 50 conveniently stores in suitable memory locations the identification numbers ID of the control nodes of the electric system and other security information (e.g. logins, passwords, and the like) required by each control node Cᵢ of the electric system for wireless communicating at local level with it.

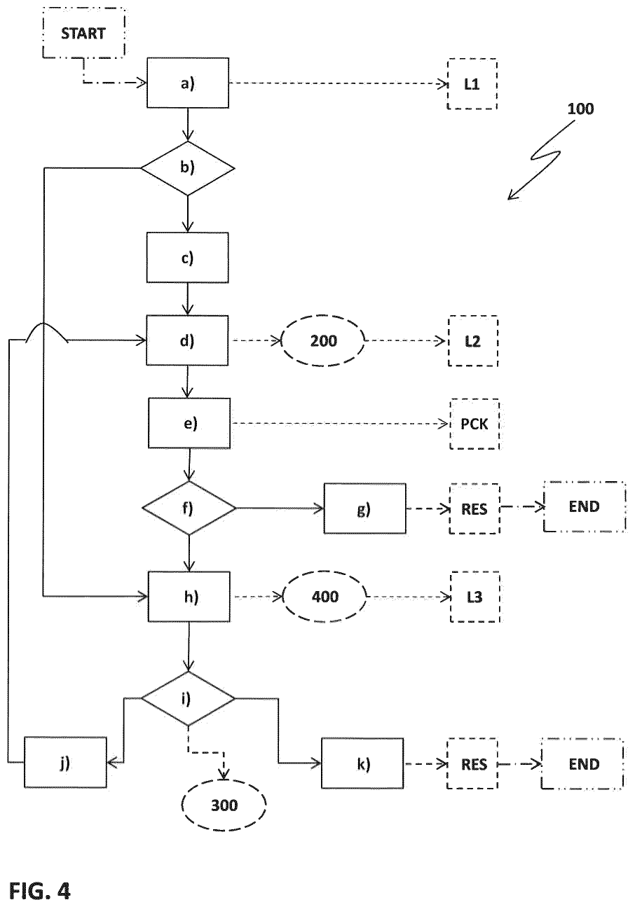

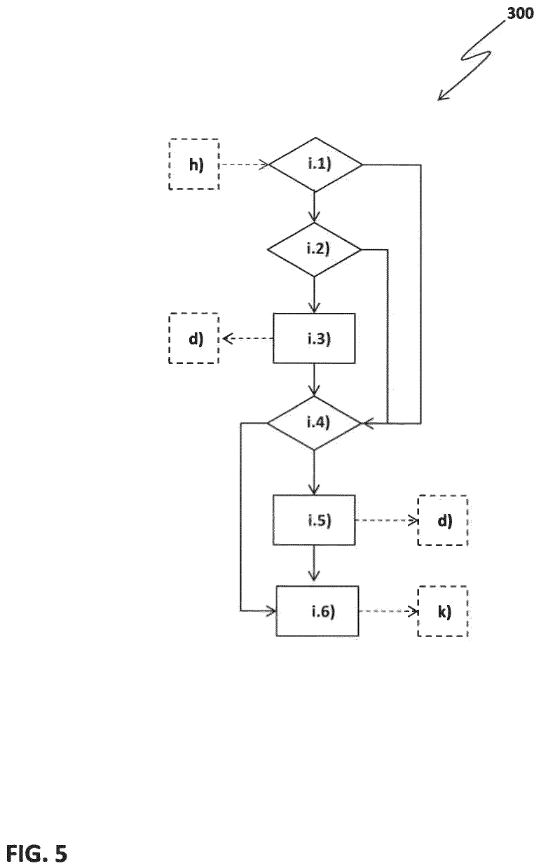

The steps of the method 100 will be now described in details with reference to the FIGS. 4-5. For the sake of clarity, some additional terms used to describe the method 100, according to the disclosure, are here defined in more details.

For the purposes of the disclosure, the term “undiscovered control nodes of interest” identifies the nodes of interest (included in the first list L1 of control nodes), which have not been already discovered by means of suitable path-finder procedures 200 and 400, at a given execution stage of the method 100.

For the purposes of the disclosure, the term “discovered control nodes of interest” identifies the nodes of interest (included in the first list L1 of control nodes), which have already been discovered by means of the above-mentioned path-finder procedures 200 and 400, at a given execution stage of the method 100.

Obviously, at an initial stage of the method 100, all nodes of interest included in the first list L1 of control nodes will be “undiscovered control nodes of interest” by definition.

On the other hand, at a final stage of the method 100, all or many nodes of interest included in the first list L1 of control nodes will be “discovered control nodes of interest” (it may happen that some nodes of interest are not found at all).

For the purposes of the disclosure, the term “reference control node” identifies a node of interest that should represent a starting node (pivot node) for carrying out a path-finder procedure, in particular the path-finder procedure 200 described in the following.

For the purposes of the disclosure, the term “control nodes of interest” identifies the control nodes of the electric system, with which a wireless communication is intended to be carried out at a given execution session of the method 100.

The method 100 is basically directed to wireless communicate at local level with one or more control nodes of interest of an electric system.

The method 100 includes an initial step a) that includes generating a first list L1 of control nodes including control nodes of interest intended for communication.

In general, for an electric system including N (positive integer number) control nodes, the above-mentioned first list L1 of control nodes will include K (positive integer number) control nodes of interest, with K<=N.

Referring to the exemplary electric system of FIG. 1, the control nodes of interest included in the first list L1 of control nodes will be, for example, the control nodes C1, C2, C4, C5 and C7 (highlighted in grey color).

The generation process of the first list L1 of control nodes may be responsive to suitable inputs provided by user through a suitable graphic user interface or buttons made available by the portable computerized device 50.

The selection of the control nodes of interest is conveniently carried out basing on the identification numbers ID of the control nodes of the electric system, which are advantageously stored in a memory location of the portable computerized device 50.

The step a) of the method 100 further includes generating a command to exchange predefined one or more information packets PCK with the control nodes of interest included in the first list L1.

Conveniently, the command generated at the step a) triggers the execution of the remaining steps of the method 100.

Some steps of the method 100, such as the following steps d) and h) are basically directed to progressively reconstruct the actual topology of the above-mentioned control nodes of interest (and possibly of other control nodes) through the recursive execution of suitable path-finder procedures 200 and 400.

Other steps of the method 100, such as the following step e), are instead directed to complete the exchange of information packets PCK for the control nodes of interest progressively discovered in the above-mentioned reconstruction process and, at the same time, to avoid undesired redundancies in the information exchange process.

Following the above mentioned step a), the method 100 includes some preliminary steps b) and c), in which a generic control node of interest of the electric system is approached. These preliminary steps are conveniently prodromal to a following cyclic execution of sequences of steps involving the above-mentioned path-finder procedures 200 and 400 and the above-mentioned the exchange of information packets PCK with the control nodes of interest progressively discovered by the path-finder procedures.

Following the above mentioned step a), the method 100 thus includes the step b) of checking whether a wireless communication at local level can be established with a control node of interest included in the first list L1 of control nodes.

A control node of interest of the first list L1 can be selected in response to suitable inputs provided by the operator through a suitable graphic user interface or buttons.

As an alternatively, a control node of interest may be selected in order of list or randomly or basing on the intensity of the wireless signal provided by the communication module of the control node.

In order to establish a communication channel with a given control node of interest of the first list L1 of control nodes, the portable computerized device 50 can start negotiating with this latter according to the modalities foreseen by the employed wireless communication protocol and, conveniently, by providing the corresponding password stored in a memory location of the portable computerized device 50.

If this process of establishing a communication channel fails for a given control node of interest of the first list L1 of control nodes, a new control node of interest is selected and checked until ending the first list L1 of control nodes.

If a wireless communication at local level cannot be established with any given control node of interest included in the first list L1 of control nodes, the method 100 provides for directly executing the following step h), which will be better described later on.

If a wireless communication at local level can be established with a given control node of interest included in the first list L1 of control nodes, the method 100 provides the step c) of selecting the given control node of interest as a reference control node.

Following the above-mentioned step c), the method 100 includes a step d) that includes executing a first path-finder procedure 200 to discover possible control nodes interconnected, in a wired manner, with the reference control node.

Referring to the exemplary electric system of FIG. 1, supposing that the control node C1 (which is a control node of interest) has been selected as a reference control node, the control nodes included in the second list L2 of control nodes will include, for example, the control nodes C2 and C3 that are interconnected with the control node C1 in a wired manner.

The first path-finder procedure 200 includes executing a suitable wired network discovery algorithm (e.g. a known DNS-SD algorithm) through the above-mentioned reference control node.

The step d) of the method 100 further includes generating a second list L2 of control nodes including the above-mentioned reference control node and other possible control nodes interconnected, in a wired manner, with the reference control node, which have been discovered by executing the first path-finder procedure 200.

In general, the second list L2 of control nodes may include, in addition to the above-mentioned reference control node, control nodes of interest and/or control nodes not being control nodes of interest.

In general, if the second list L2 of control nodes includes some control nodes of interest, these latter may be undiscovered control nodes of interest and/or discovered control nodes of interest.

Additionally, the above-mentioned reference control node may be an undiscovered control node of interest or a discovered control node of interest.

Obviously, if the path-finder procedure is carried out for the first time, the above-mentioned reference control node will necessary be an undiscovered control node of interest.

According to the disclosure, the method 100 includes a step e) that includes selecting possible undiscovered control nodes of interest included in the second list L2 of control nodes and exchanging information packets PCK with the selected undiscovered control nodes of interest.

The step e) of the method 100 is basically directed to complete the exchange of information packets PCK for the control nodes of interest identified at the previous step d), which have not already been discovered yet.

In this way, undesired redundancies of the information exchange process with the control nodes of the electric system are conveniently prevented.

As an example, if the method 100 is carried out with the aim of configuring some control nodes of the electric system, this solution ensures that each control node of interest receives the configuration data only once, even if it has been retrieved many times during the execution of the method itself, e.g. due to the fact that is arranged in proximity of other control nodes of the electric system or it is interconnected with the control nodes.

The exchange of information packets PCK with the possible undiscovered control nodes may occur according to solutions of known type.

According to a possible solution, the step e) of the method 100 may include exchanging the information packets PCK with the undiscovered control nodes of interest in a parallel manner, e.g. according to suitable multi-casting communication algorithms of known type.

According to an alternative approach, the step e) of the method 100 may include exchanging the information packets PCK with the undiscovered control nodes of interest in a sequential manner, e.g. by exchanging information with a single undiscovered control node (e.g. the reference control node), which in turn operates a receiver or transmitter of information with the remaining undiscovered control nodes.

In general, when the step e) is executed for the first time, undiscovered control nodes of interest are always found.

However, at following interaction cycles of the method 100, undiscovered control nodes of interest may not be present in the second list L2 of control nodes.

In this case, the above-mentioned information exchange process included in the step e) of the method 100 is merely skipped and the following steps of the method 100 are carried out.

According to the disclosure, following the above-mentioned step e), the method 100 includes the step f) checking whether there are undiscovered control nodes of interest in the above-mentioned first list L1 of control nodes.

The step f) is basically directed to check whether all the control nodes of interest included in the list L1 have been discovered.

Obviously, at initial cycles of the method 100, the step f) is somehow trivial as the first list L1 of control nodes generally includes a huge number of control nodes.

However, its execution is nevertheless important as it provides for checking whether certain conditions for terminating the method 100 are present.

Following the step f), the method 100 includes the step g) of terminating the method, if no more undiscovered control nodes of interest are present in the mentioned first list L1 of control nodes.

The termination step includes providing output data RES indicative of execution results of the method.

Conveniently, output data RES include information indicative of whether all information exchanges with the progressively discovered control nodes of interest have been successful or the communication processed did not have a successful outcome for some control nodes.

Of course, additional information, such as reports or statistics related to the execution of the method 100, may be included in the output data RES as well.

Following the step f), the method 100 includes the step h) of executing a second path-finder procedure 400 to obtain a third list L3 of control nodes located within a local wireless communication range of the portable computerized device 50.

Conveniently, the step h) of the method 100 is carried out if there are undiscovered control nodes of interest in the first list L1 of control nodes, upon the check carried out at the above-mentioned step f) of the method 100.

As mentioned above, the step h) of the method 100 may also be carried out, if a local wireless communication cannot be established with a control node of interest of the first list L1 of control nodes at the initial step b) of the method 100.

The second path-finder procedure 400 includes executing a suitable wireless network scanning algorithm (which may be a known WiFi™ scanning algorithm) at one or more locations of the electric system.

In general, the above-mentioned third list L3 of control nodes may include control nodes of interest and/or control nodes not being control nodes of interest or even no control nodes, if the above-mentioned second path-finder procedure 400 does not allow to discover any control node.

Obtaining of above-mentioned third list L3 of control nodes is anyway important as it allows checking whether certain conditions for terminating the method 100 are present by means of a suitable determination procedure 300. The method 100 is terminated if no control node of the third list L3 of control nodes may be selected as reference control node. Otherwise, the above-mentioned steps d)-h) are repeated taking a control node of the third list L3 as new reference control node.

Following the above-mentioned step h), the method 100 includes the step i) of carrying out a determination procedure 300 to check whether a control node of the third list L3 of control nodes is selectable as a reference control node.

If a control node of the third list L3 of control nodes is selectable as a reference control node, the method 100 includes the step j) of repeating the previous steps of the method 100 by starting from the above-mentioned step d) and by using the checked selectable control node of the third list L3 as reference control node.

Otherwise, if no control node of the third list L3 of control nodes is selectable as a reference control node, the method 100 includes the step k) of terminating the method.

Also in this case, the termination of the method 100 includes providing output data RES indicative of execution results of the method.

As mentioned above, output data RES include information indicative of the outcome of the information exchanged with the found control node of interest and, possibly, additional information, such as reports or statistics related to the execution of the method 100.

The determination procedure 300 is articulated in a sequence of steps i.1)-i.6) that provides for implementing subsequent differentiated checking levels to determine whether a control node of the third list L3 of control nodes is selectable as a (new) reference control node. Referring now to FIG. 5, the determination procedure 300 is now illustrated in more details.

The determination procedure 300 includes an initial step i.1) of checking whether there are undiscovered control nodes of interest included in the third list L3 of control nodes.

In practice, the step i.1) provides for checking whether the third list L3 of control nodes includes some control nodes (included in the first list L1 of control nodes) that have not already been found by means of the above-mentioned path-finder procedures 200 and 400, at this execution stage of the method 100.

If there are one or more undiscovered control nodes of interest included in the third list L3 of control nodes, the determination procedure 300 includes a step i.2) of checking whether a wireless communication channel can be established with an undiscovered control node of interest included in the third list L3.

An undiscovered control node of interest to be checked at the step i.2) can be selected in response to suitable inputs provided by the operator through a suitable graphic user interface or button.

As an alternative, an undiscovered control node of interest to be checked may be selected in order of list or randomly or basing on the intensity of the wireless signal provided by the control node.

In order to establish a communication channel with a given undiscovered control node of interest of the third list L3 of control nodes, the portable computerized device 50 can start negotiating with the control node according to the modalities foreseen by the employed wireless communication protocol, for example by providing the corresponding password.

If this process of establishing a communication channels fails for a given undiscovered control node of interest of the third list L3 of control nodes, a new undiscovered control node of interest may be selected until ending the third list L3 of control nodes.

If a wireless communication channel can be established with an undiscovered control node of interest included in the third list L3 of control nodes, the determination procedure 300 includes a step i.3) of selecting the undiscovered control node of interest as a reference control node. In this case, the above-mentioned steps d)-h) will be repeated taking the selected undiscovered control node of the third list L3 as new reference control node according to the above-mentioned step j) of the method 100.

If the above-mentioned checking steps i.1) or i.2) fail, i.e. if there are no undiscovered control nodes of interest included in the third list L3 of control nodes or if a wireless communication channel cannot be established with any undiscovered control node of interest included in the third list L3 of control nodes, the determination procedure 300 includes a step i.4) of checking whether there a wireless communication channel can be established with any control node included in the third list L3 of control nodes.

The step i.4) is basically directed to check whether there are any available control nodes in the third list L3 of control nodes, with which a communication can be established. The control nodes checked at the step i.4) cannot be undiscovered control nodes of interest. However, they may be discovered control nodes of interest (included in the first list L1 of control nodes) or even control nodes not included in the first list L1 of control nodes.

Basically, the above-mentioned step i.4) of the determination procedure 300 can be carried in a known manner similar to that one illustrated for the above-mentioned step i.3) of the determination procedure 300.

If a wireless communication channel can be established with a control node included in the third list L3 of control nodes, the determination procedure 300 includes a step i.5) of determining that the control node is selectable as a reference control node. In this case, the above-mentioned steps d)-h) will be repeated taking the selected control node of the third list L3 as new reference control node, according to the above-mentioned step j) of the method 100.

As it may be easily understood, the above-mentioned steps i.4)-i.5) of the determination procedure 300 represent a sort of final attempt of finding a generic control node of the electric system, which might be interconnected with an undiscovered control node of interest and which might allow finding such an undiscovered control node of interest by executing the above-mentioned first path-finder procedure 200.

If also the checking step i.4) fails, i.e. if a wireless communication channel cannot be established with any control node included in the third list L3 of control nodes, the determination procedure 300 includes a step i.6) of determining that no control node of the third list L3 of control nodes is selectable as a reference control node. In this case, the method 100 is terminated, according to the above-mentioned step k) of the method 100.

As it may be easily understood from the above, the method 100 may include multiple repetition cycles of the above-described steps d)-f) and h)-j).

At each repetition cycle, the actual topology of the above-mentioned control nodes of interest (and possibly of other control nodes) is progressively reconstructed by means of path-finder procedures of different types (i.e. using wired-implemented or wireless-implemented discovery algorithms) and the exchange of information packets PCK with the control nodes of interest is progressively completed, without undesired redundancies in the information exchange process.

The method 100 includes a step (not shown in FIG. 4) of updating a map M of the control nodes of the electric system.

Conveniently, such an updating step may be carried out following the execution of the above-mentioned path-finder procedures 200 and/or 400.

Conveniently, the map M, which is basically aimed at reconstructing the topology of the control nodes of the electric system, is stored by the portable computerized device 50 in such a way to be used and possibly updated at following execution sessions of the method itself.

### EXAMPLE

A simplified example of implementation of the method 1 is now illustrated with reference to the network of control nodes C1-C7 in the exemplary electric system shown in FIG. 1.

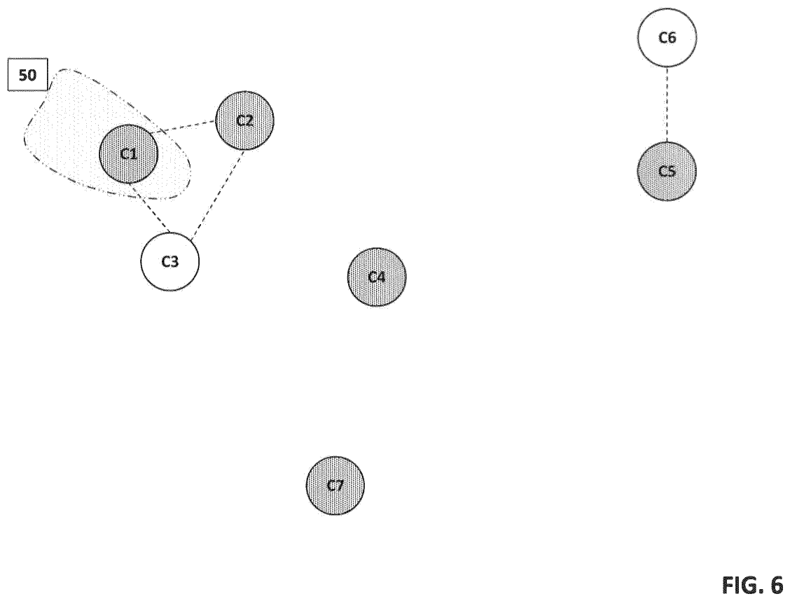

Referring to FIG. 6, according to the step a) of the method 100, a first list L1 of control nodes including the control nodes of interest for communication purposes (highlighted in grey in FIGS. 1, 4) is generated.

In this case, the first list L1 of control nodes includes the control nodes C1, C2, C4, C5, C7.

According to the step b) of the method 100, it is determined that a communication is established with the control node C1, which is thus selected as reference control node according to step c) of the method 100.

According to the step d) of the method 100, a first path-finder procedure 200 is executed through the reference control node C1 and the second list L2 of control nodes is generated.

In this case, the second list L2 of control nodes includes the control nodes C1, C2, C3.

According to the step e) of the method 100, the control nodes C1, C2 are selected as undiscovered control nodes of interest included in the second list L2 of control nodes. Information packets PCK are thus exchanged with the selected undiscovered control nodes of interest C1, C2.

According to the step f) of the method 100, it is then checked whether there are still undiscovered control nodes of interest in the first list L1 of control nodes. In this case, the first list L1 of control nodes still includes the undiscovered control nodes of interest C4, C5, C7.

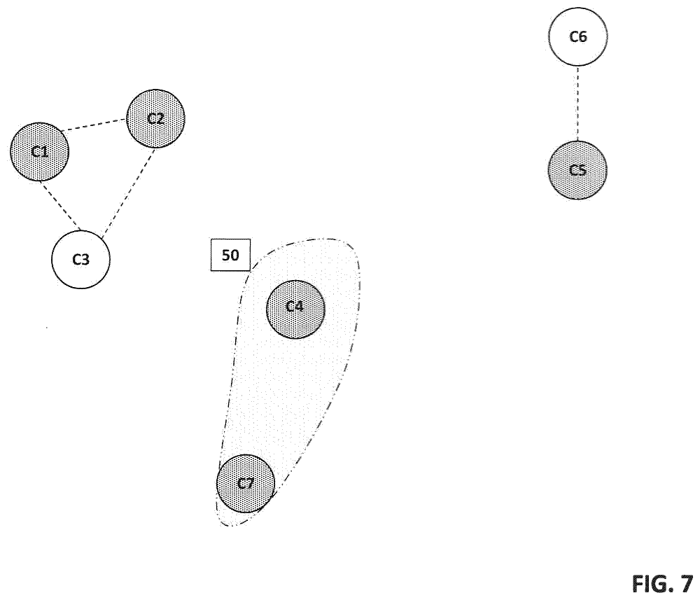

Conveniently, the portable computerized device 50 is moved through the electric system and, according to the step h) of the method 100, a second path-finder procedure 400 is executed (FIG. 7). A third list L3 of control nodes located within a local wireless communication range is thus generated. In this case, the third list L3 of control nodes includes the control nodes C4, C7.

According to the step i) of the method 100, the determination procedure 300 is carried out to check whether a control node of the third list L3 of control nodes is selectable as a reference control node.

It is supposed that a communication can be established with the control node C4 only, as this latter is closer to the portable computerized device.

The control node C4 is thus determined as selectable for being a new reference control node, according to steps i.1)-i.3) of the determination procedure 100.

According to the step j) of the method 100, the previous steps are repeated by starting from step d) and by selecting the selectable control node C4 as a new reference control node.

According to the step d) of the method 100, the first path-finder procedure 200 is executed through the new reference control node C4 and a new second list L2 of control nodes is generated. In this case, the second list L2 of control nodes includes the sole control node C4. According to the step e) of the method 100, the control node C4 is selected as undiscovered control node of interest included in the new second list L2 of control nodes. Information packets PCK are thus exchanged with the selected undiscovered control nodes of interest C4. According to the step f) of the method 100, it is then checked whether there are still undiscovered control nodes of interest in the first list L1 of control nodes. In this case, the first list L1 of control nodes still includes the undiscovered control nodes of interest C5, C7.

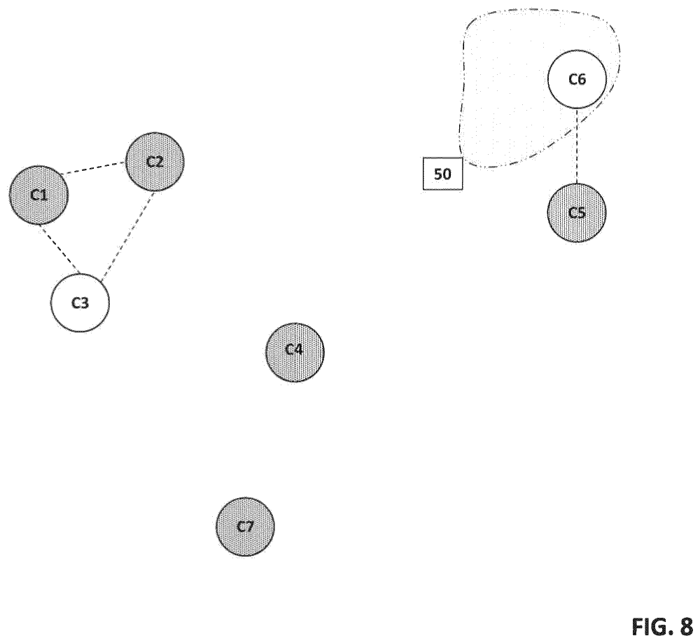

Conveniently, the portable computerized device 50 is moved through the electric system and, according to the step h) of the method 100, the second path-finder procedure 400 is executed (FIG. 8).

A new third list L3 of control nodes located within a local wireless communication range is thus generated. In this case, the new third list L3 of control nodes includes the sole control node C6, which is not a control node of interest.

According to the step i) of the method 100, the determination procedure 300 is carried out to check whether the control node C6 of the third list L3 of control nodes is selectable as a reference control node.

It is supposed that a communication can be established with the control node C6. Such a control node with thus be determined as selectable for being a new reference control node, according to steps i.4)-i.5) of the determination procedure 100.

According to the step j) of the method 100, the previous steps are repeated by starting from step d) and by selecting the selectable control node C6 as a new reference control node.

According to the step d) of the method 100, the first path-finder procedure 200 is executed through the new reference control node C6 and a new second list L2 of control nodes is generated. In this case, the second list L2 of control nodes includes the control node C6 and the undiscovered control node of interest C5, which is interconnected with the control node C6.

According to the step e) of the method 100, the control node C5 is selected as undiscovered control node of interest included in the new second list L2 of control nodes (whereas the reference control node C6 is not considered as not being a control node of interest). Information packets PCK are thus exchanged with the selected undiscovered control nodes of interest C5.

According to the step f) of the method 100, it is then checked whether there are still undiscovered control nodes of interest in the first list L1 of control nodes. In this case, the first list L1 of control nodes still includes the undiscovered control node of interest C7.

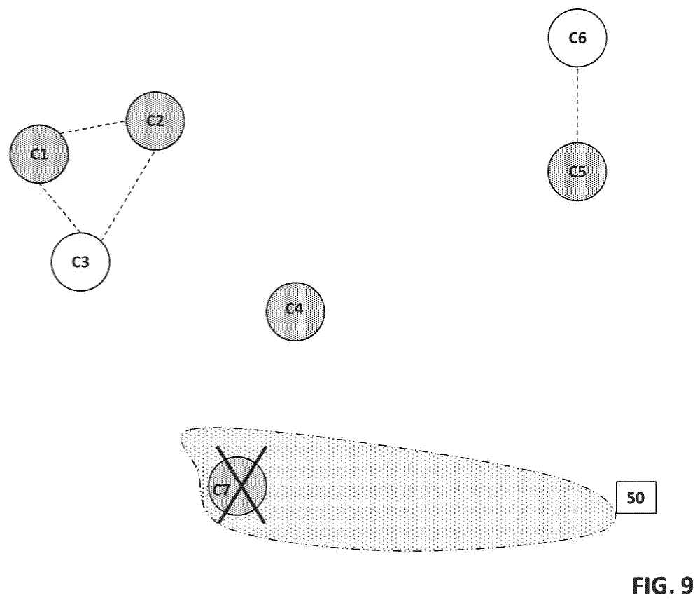

Conveniently, the portable computerized device 50 is moved through the electric system and, according to the step h) of the method 100, the second path-finder procedure 400 is executed (FIG. 9).

A new third list L3 of control nodes located within a local wireless communication range is thus generated. In this case, the new third list L3 of control nodes includes the sole control node C7, which is an undiscovered control node of interest.

According to the step i) of the method 100, the determination procedure 300 is carried out to check whether the control node C7 of the third list L3 of control nodes is selectable as a reference control node.

It is supposed that a communication cannot be established with the control node C7 due to its isolated position.

As it is additionally impossible to establish a wireless communication with another control node of the third list L3 of control nodes (as only the control node C7 is included therein), it is determined that no selectable control nodes are present in the third list L3.

According to the step k), the method 100 is terminated.

Output data RES will report that the exchange of information packets PCK was successful for the control nodes C1, C2, C4, C5 and failed for the control node C7.

An updated map M of the topology of the control nodes C1-C7 is conveniently stored in the computerized portable device 50 following the above-illustrated execution session of the method 100.

As the skilled person will certainly understand, additional examples of implementation of the method are possible, according to the needs.

The method 100, according to the disclosure, provides relevant advantages with respect to known solutions of the state of the art.

The method 100 allows interacting with multiple control nodes of an electric system in a simple and direct manner, even without having a detailed knowledge of the actual topology of the control nodes.

In order to complete transmission/reception of information packets CKP to/from the control nodes, a user has merely to walk through an electric system with the portable computerized device 50 implementing the method 100.

The method 100 allows obtaining a dramatic reduction of time necessary for carrying out an information exchange process with the control nodes of the electric system. This entails remarkable savings in terms of manpower costs, for example during maintenance interventions or commissioning activities of the electric system.

As communication may occur with multiple control nodes at a time, the method 100 further allows reducing the power consumed by the control nodes of the electric system for carrying out an information exchange process, e.g. for being configured during commissioning activities of the electric system.

The method, according to the present disclosure, is particularly adapted to be implemented by a portable computerized device without the need of specific hardware resources.

The method, according to the disclosure, is particularly adapted for being implemented in digitally enabled power distribution networks (smart grids, micro-grids and the like) and renewable power generation plants, in particular photovoltaic plants.

1. A method for wireless communicating at a local level with one or more control nodes of an electric system, the control nodes included in or operatively associated with corresponding electric or electronic apparatuses of the electric system and capable of communicating at the local level with a computerized device, wherein the method comprises the following steps:
a) generating a first list of control nodes including control nodes of interest intended for communication and generating a command to exchange information packets with the control nodes of interest;
b) checking whether a wireless communication at the local level can be established with a control node of interest included in the first list of control nodes;
c) if a wireless communication at the local level can be established with a control node of interest included in the first list of control nodes, selecting the control node of interest as a reference control node;
d) executing a first path-finder procedure through the reference control node to identify possible control nodes interconnected, in a wired manner, with the reference control node and generating a second list of control nodes including the reference control node and possible control nodes interconnected, in a wired manner, with the reference control node;
e) selecting possible undiscovered control nodes of interest included in the second list (L2) of control nodes and exchanging the information packets with the selected undiscovered control nodes of interest;
f) checking whether there are undiscovered control nodes of interest in the first list of control nodes;
g) if there are no undiscovered control nodes of interest in the first list of control nodes, terminate the method;
h) if a local wireless communication cannot be established with a control node of interest in the first list of control nodes at the step b) of the method or if there are undiscovered control nodes of interest in the first list of control nodes, executing a second path-finder procedure to generate a third list of control nodes located within a local wireless communication range;
i) carrying out a determination procedure to check whether a control node of the third list of control nodes is selectable as a reference control node;
j) if a control node of the third list of control nodes is selectable as a reference control node, repeating the previous steps by starting from step d) and by selecting the selectable control node as a reference control node; or
k) if no control node of the third list of control nodes is selectable as a reference control node, terminate the method.

2. The method according to claim 1, wherein the determination procedure comprises the following steps:
i.1) checking whether there are undiscovered control nodes of interest included in the third list of control nodes;
i.2) if there are undiscovered control nodes of interest included in the third list of control nodes, checking whether a wireless communication channel can be established with an undiscovered control node of interest included in the third list;
i.3) if a wireless communication channel can be established with an undiscovered control node of interest included in the third list of control nodes, determining that the undiscovered control node of interest is selectable as a reference control node;
i.4) if there are no undiscovered control nodes of interest included in the third list of control nodes or if a wireless communication channel cannot be established with any undiscovered control node of interest included in the third list of control nodes, checking whether a wireless communication channel can be established with any control node included in the third list of control nodes;
i.5) if a wireless communication channel can be established with a control node included in the third list of control nodes, determining that the control node is selectable as a reference control node);
i.6) if a wireless communication channel cannot be established with any control node included in the third list of control nodes, determining that no control node included in the third list of control nodes is selectable as a reference control node.

3. A method according to claim 1, wherein the first path-finder procedure includes executing a wired network discovery algorithm through the reference control node.

4. A method according to claim 1, wherein the step e) of the method includes exchanging the information packets with possible undiscovered control nodes of interest in a parallel manner.

5. A method according to claim 1, wherein the step e) of the method includes exchanging the information packets with possible undiscovered control nodes of interest in a sequential manner.

6. The method according to claim 1, wherein the second path-finder procedure includes executing a wireless network scanning algorithm.

7. The method according to claim 1, wherein the termination of the method includes providing output data indicative of execution results of the method.

8. The method according to claim 1 further comprising a step of updating a map of the control nodes of the electric system.

9. The method according to claim 1, wherein the electric system is a photovoltaic plant, each control node being included in or operatively associated with a photovoltaic inverter of the photovoltaic plant.

10. A computer program including software instructions storable in a memory and configured to carry out the method according to claim 1 when executed by data processing resources of a computerized device.

11. A portable computerized device comprising a control module including data processing resources and a local wireless communication port adapted to interact with the control module to exchange information packets with one or more external devices through a wireless communication at the local level, wherein the data processing resources are capable of executing software instructions stored in a memory and configured to carry out the method according to claim 1.
